(19) United States
(12) Patent Application Publication
(10) Pub. No.: US 2017/0165567 A1
(43) Pub. Date: Jun. 15, 2017

(54) HAPTIC MECHANISM FOR VIRTUAL REALITY AND AUGMENTED REALITY INTERFACES

(71) Applicant: PALM LABORATORIES INC., Brooklyn, NY (US)

(72) Inventor: Shaw Nicola Walters, Brooklyn, NY (US)

(73) Assignee: PALM LABORATORIES INC., Brooklyn, NY (US)

(21) Appl. No.: 15/374,892

(22) Filed: Dec. 9, 2016

Related U.S. Application Data
(60) Provisional application No. 62/265,607, filed on Dec. 10, 2015.

(51) Int. Cl. A63F 13/285; A63F 13/24; A63F 13/212

(52) U.S. Cl. CPC A63F 13/285; A63F 13/212; A63F 13/24; A63F 2300/8082

(57) ABSTRACT

According to at least one aspect, a haptic mechanism is provided. The haptic mechanism includes an anchoring element configured to be worn about a portion of a subject, a tensioning cable coupled to the anchoring element, and a retraction mechanism coupled to the tensioning cable. The retraction mechanism includes a brake configured to controllably impede movement of the tensioning cable to impede motion of the anchoring element in at least one direction.

### CROSS-REFERENCE TO RELATED APPLICATIONS

This application claims the benefit under 35 U.S.C. §119(e) of U.S. provisional patent application Ser. No. 62/265,607 titled “GLOVE MECHANISM FOR VIRTUAL REALITY AND AUGMENTED REALITY INTERFACES,” filed on Dec. 10, 2015, which is hereby incorporated herein by reference in its entirety.

### FIELD

Aspects of the technology described herein relate generally to input and output controllers, and more specifically to input and output controllers used in virtual reality (VR) and augmented reality (AR) applications.

### BACKGROUND

Virtual reality (VR) systems typically simulate places in real or imaginary worlds. For example, a VR system may provide a user a simulated experience of being in a famous location such as the Taj Mahal in India. VR systems typically provide the user with an immersive experience for the human senses of sight and sound. A headset is typically employed to provide the immersive experience for human sight by providing the user a view of the real or imaginary world that tracks the user's head movements. The immersive experience for human sound is typically provided by headphones that provide sound that changes as the user navigates the world to mimic the changes that would be perceived by a human in the virtual world.

Augmented reality (AR) systems typically add virtual elements to a view of a real-world environment. For example, an AR system may overlay information about a landmark (e.g., a height of the landmark, an age of the landmark, and a creator of the landmark) onto the user's view of the landmark. AR systems typically project images into a transparent plate that allows a user to both see the real-world environment behind the transparent plate and the images projected into the transparent plate.

### SUMMARY

Aspects of the present disclosure relate to a haptic mechanism for using resistive force and/or retractive force applied to the fingers, hands, arms and/or other appendages of a user for the purpose of providing haptic feedback that creates physical sensations to recreate the sense of touch. Resistive force may impede or entirely inhibit the opening or closing of a joint of a subject in at least one direction. For example, a resistive force may stop a subject from opening an elbow joint more than 50 degrees. Retractive force may pull (or push) a portion of a subject to open (or close) a joint. For example, a retractive force may pull a forearm of subject to increase an opening of the elbow joint of the subject. The resistive and/or retractive forces exerted by the haptic mechanism simulate the physical properties of virtual objects or surfaces, most notably volume and solidness, compensating for the user's movement in physical space by restricting their movement and/or retracting limbs that are colliding with a virtual object or surface. In one implementation, the haptic mechanism interfaces with a computer or mobile device to simulate the physical experience of grabbing, pushing, pulling, pressing, twisting and/or picking up of virtual objects, as well as pushing against hard surfaces or colliding with moving or expanding objects.

With the prevalence of virtual reality (VR) and augmented reality (AR) systems, especially stereoscopic head-mounted displays, methods for allowing a user to interact with computers and digital worlds are necessary. In one implementation, a haptic mechanism is provided that is a replacement for a traditional mouse, keyboard, gamepad, or joystick interaction, specifically for operating within a virtual environment. Conventional devices attempt to mimic common sensory experiences to bridge the divide between the virtual and real world, and serve as both an input and output device, however these conventional devices are not suited for providing realistic experiences. For example, a game controller may include buttons to receive input from a user and provide feedback to the user through a vibration device integrated into the game controller. Such a conventional device fails to provide a realistic experience of touching virtual objects in a virtual world.

While many haptic devices already exist, none have addressed the needs of the consumer market as a simple, cost-effective, and portable device to simulate the physical aspects of a virtual environment or virtual objects within a virtual environment in a realistic way. Various aspects of the present disclosure address such a need by simulating physical properties with force feedback, either as resistance to user motion or retraction of a user's limbs to a point in physical space where their appendage is not colliding with a virtual object.

According to one embodiment, a haptic mechanism is provided that includes a novel combination of actuators, retraction mechanisms, and tensioning cables to apply resistive and/or retractive force to portions of a subject (e.g., fingers, hand, and arm), and methods and systems for interfacing with such a haptic mechanism. Conventional systems, including vibrating haptic gloves (e.g., the GLOVEONE made by NEURODIGITAL TECHNOLOGIES) exist, as do data gloves which measure finger flexion and hand position (e.g., the POWERGLOVE by NINTENDO, the CYBERGLOVE by CYBERGLOVE SYSTEMS, P5 DATAGLOVE by ESSENTIAL REALITY, and the MI.MU GLOVE by MI.MU). However, none of these products physically exert resistive or retractive forces on the user. While expensive industrial designs such as the CYBERGRASP by CYBERGLOVE SYSTEMS simulate similar resistive force mechanisms, they are far too complex, expensive, and cumbersome for practical use. Also, it is appreciated that there are no existing consumer-based products that provide a resistive force mechanism in a customer apparatus designed for applications in virtual and augmented reality environments, including telepresence and gaming. Therefore, a haptic mechanism is provided that provides resistive force and/or retraction force yet can be manufactured for such mainstream applications.

According to one embodiment, a haptic mechanism is provided that is integrated with a standard wearable glove and arm band to form a haptic glove. However, it should be appreciated that other types of haptic devices that are used with other parts of the body may be designed. For instance, the same or similar haptic mechanisms could be implemented for any part of the body, or even as a whole suit.

According to one embodiment, a haptic glove is provided that includes retractable tensioning cables contained within the haptic glove. These tensioning cables originate from the top of the hand and extend to the tips of the fingers. Upon contact with a virtual object, a retraction mechanism exerts an opposing force on the tensioning cables, effectively constricting the forward movement of the user, and, if necessary, retracting the movement of the user to a point where their limb is not colliding with a virtual object. The retraction mechanism can be any kind of mechanism that stops the tensioning cable and/or winds it back away from the affected limb. In some embodiments, the retraction mechanism may be a combination of a brake and a geared motor, for resistive force feedback and retractive force feedback respectively, or a motor that serves both functions.

In one embodiment, the retraction mechanism utilizes a channel brake, which applies friction to the tensioning cable when rotated (e.g., rotated 90 degrees) from its original rotation, effectively reducing the length of the tensioning cable and exerting a resistive force. By rotating beyond 90 degrees, the brake effectively provides a retractive force and retracts the limb.

The mechanism that applies the retractive force can be a stepper motor, servo motor, solenoid or other electrical, mechanical or pneumatic actuator, or combination of these devices. A two-step motorized retraction system may be used to balance high speed reaction with lower-speed, higher torque retraction.

The haptic glove may also contain sensors to measure flexion across the fingers of the haptic glove. These sensors may be, for example, inertial measurement units, rotary encoders, rotary potentiometers, flex sensors, hall effect sensors or similar mechanisms for measuring at least one axis and as many as three axes of rotation. Further, the haptic glove may include other elements (in any combination) such as, for example, mechanisms to cause haptic sensation, inertial measurement units to measure limb rotation as well as flexion, and a microcomputer or microcontroller to calculate the position and rotation of the hand in three dimensions (6 degrees of freedom) and flexion of the fingers in one dimension.

The haptic glove may include an on-board microcomputer or microcontroller that communicates with a host computer or mobile device via USB, BLUETOOTH, or other form of standardized wired or wireless communication. Input data is passed from the on-board computer into the host computer and output data is passed back to the on-board computer. The communication may rely on a packet structure that may be processed directly within a software program, and when executed processes information relating to the virtual environment, or through middleware software that receives the data and transmits the data to the host software via UDP, TCP or similar protocol. Information passed to the on-board computer via the serial-based protocol is responsible for the actual retraction of the mechanism as well as providing additional position and rotational data.

According to one aspect of the present disclosure, an improved haptic glove is provided that provides feedback to a user's fingertips. In one example haptic glove, a tensioning cable is fed through the channel brake and attaches on one end to the fingertip and on the other end to the tensioning mechanism. When the user collides with a virtual object in space, the retraction mechanism rotates the channel brake and stops the tensioning cable's forward movement using friction. The tensioning mechanism counters the force of the channel brake to create maximum friction while retraction mechanism is engaged. The user is unable to move their fingers (or limbs) forward in a way that elongates the length of the tensioning cable in this state, and may even have their fingers (or limbs) retracted if they are colliding with a virtual object. As soon as the user's limb is no longer colliding with the object, the retraction mechanism rotates the channel brake back to its rest position.

In an alternative embodiment, the haptic glove may be designed in a way so as to guide the tensioning cables above the hand and down to the tips of the fingers from above, instead of running along the top of the fingers. Alternatively, the glove mechanism can be designed without a glove to rest on top of the hand, with the hands and fingers connected to the glove mechanism by rings, loops or bands made of a connective material.

The tensioning mechanism may be any kind of mechanism that provides minimal force to keep the tensioning cables pulled back. This may be, for example, an elastic member or a spring, often in combination with a spool. For instance, the motor may engage and pull the finger, hand or other appendage away from the virtual object it is colliding with (e.g., a virtual representation of the finger, hand or other appendage within a virtual environment).

In another implementation, the armband may use a similar resistive force mechanism applied to the movement of the arm. For instance, the armband may include tensioning cables than can be connected to the haptic glove and a vest to limit the range of motion of the arm to simulate the experience of pushing a virtual object or pressing up against a virtual surface or wall.

A similar haptic mechanism can also be applied to the body, restricting motion of the arm and back. This could, for example, prevent the user from leaning into a wall, or simulate a virtual object's simulated mass by increasing resistance when the user attempts to pull or lift an object.

Similar haptic mechanisms can be located on a chassis, truss, or scaffolding separate from the body, to restrict the user's movement within a volume of space. This could, for example, apply the same retractive effect to the user in more dimensions, and could be combined with a mechanism that allows the user to move in a virtual environment while staying in place in their physical environment.

According to another embodiment, a mechanism may be provided within the haptic glove that provides a sensation of touch to the fingertips of the subject. In one implementation, a fingertip portion of the glove may house a mechanism to simulate the sensation of touch. This mechanism may include small rollers rotated by a motor. The rollers can be designed asymmetrically to create the feeling of pressure against the fingertips.

According to one aspect of the present disclosure, a glove mechanism is provided comprising at least one actuator, a braking retraction mechanism, and a tensioning cable coupled to the at least one actuator, braking retraction mechanism and a finger element of the glove, wherein the braking retraction mechanism is adapted to exert a resistive and/or retractive force to the finger via the tensioning cable. According to one embodiment, the braking retraction mechanism includes a channel brake having a channel, and wherein the tensioning cable is routed through the channel of the channel brake. According to one embodiment, the channel of the braking retraction mechanism is positioned within a rotating element, and wherein a rotation of the rotating element causes the tensioning cable to apply a resistive retractive force to the finger element. According to another embodiment, the tensioning cable is retractable and contained within the glove mechanism.

According to an alternative embodiment, the tensioning cable is routed through a guide along the top of a finger to the finger element. According to one embodiment, the finger element includes a cap within which a finger is inserted. According to one embodiment, the braking retraction mechanism is adapted to assert a resistive or retractive force on the tensioning cable. According to another embodiment, the braking retraction mechanism includes at least one of a group comprising a U-brake, a channel brake, disk brake or rotating spool. According to yet another embodiment, the braking retraction mechanism includes at least one of a group comprising a stepper motor, servomotor, solenoid or actuator adapted to apply a braking resistive or retractive force.

According to one embodiment, the mechanism further comprises at least one rotational or flex sensor adapted to measure flexion across the finger of the glove mechanism. According to one embodiment, the mechanism further comprises an inertial measurement unit adapted to measure a position of a hand inserted in the glove mechanism in three dimensions. According to one embodiment, the glove mechanism includes a controller that receives and transmits signals to a computer system, and wherein the braking retraction mechanism receives control signals to apply the resistive force responsive to the controller receiving an indication from the computer system to apply the resistive force. According to another embodiment, the indication to apply the resistive force is determined responsive to a determination that a virtual representation of the glove mechanism has contacted a virtual object within a virtual representation of three dimensional space.

According to another embodiment, the mechanism further comprises a tensioning mechanism coupled to the tensioning cable, wherein the tensioning mechanism is adapted to apply a pulling force to the tensioning cable. According to one embodiment, the tensioning mechanism includes at least one of a group comprising an elastic member, a spring, and a motor. According to one embodiment, the mechanism includes means for providing a sensation of touch within at least one fingertip of the glove mechanism. According to another embodiment, the means for providing a sensation of touch includes a roller mechanism.

According to at least one aspect, a haptic mechanism is provided. The haptic mechanism includes an anchoring element configured to be worn about a portion of a subject, a tensioning cable coupled to the anchoring element, and a retraction mechanism coupled to the tensioning cable. The retraction mechanism includes a brake configured to controllably impede movement of the tensioning cable to impede motion of the anchoring element in at least one direction.

In some embodiments, the anchoring element includes a finger cap configured to receive a portion of a finger of the subject. In some embodiments, the anchoring element includes a band configured to worn about a portion of an arm of the subject (e.g., a forearm of the subject or a upper arm of the subject). In some embodiments, the anchoring element includes a band configured to be worn about a portion of a leg of the subject.

In some embodiments, the brake includes at least one of a U-brake, a channel brake, or a disc brake. In some embodiments, the brake includes a channel brake having a channel, and the tensioning cable is routed through the channel of the channel brake. In some embodiments, the retraction mechanism further includes an actuator configured to rotate the channel brake to impede movement of the tensioning cable through the channel. In some embodiments, the retraction mechanism is configured to apply a resistive force to the tensioning cable by rotating the channel brake up to 90 degrees from an open position where the tensioning cable can move freely through the channel. In some embodiments, the retraction mechanism is configured to apply a restrictive force to the tensioning cable by rotating the channel brake in excess of 90 degrees from an open position where the tensioning cable can move freely through the channel.

In some embodiments, the tensioning cable is retractable and contained within the haptic mechanism. In some embodiments, the tensioning cable includes a nylon core with a polyester woven wrap. In some embodiments, the tensioning cable includes a wire cable. In some embodiments, the tensioning cable includes at least one of: plastic (e.g., nylon) or metal (e.g., steel).

In some embodiments, the haptic mechanism is integrated with a garment to form a haptic device. In some embodiments, the haptic mechanism is configured to be directly worn on a portion of a subject.

In some embodiments, the retraction mechanism includes at least one of a stepper motor, a servomotor, a solenoid, or an actuator configured to operate the brake to apply a braking force to the tensioning cable.

In some embodiments, the haptic mechanism further includes at least one sensor. In some embodiments, the at least one sensor is adapted to measure flexion across at least one joint of the subject. In some embodiments, the at least one joint includes at least one of: a shoulder joint, an elbow joint, a wrist joint, a finger joint, a neck joint, a spine joint, a hip joint, a knee joint, an ankle joint, or a toe joint.

In some embodiments, the retraction mechanism includes a tensioning mechanism coupled to the tensioning cable and configured to apply a pulling force to the tensioning cable. In some embodiments, the tensioning mechanism includes at least one of an elastic member, a spring, or a motor. In some embodiments, the tensioning mechanism includes a spring (e.g., a tension spring) constructed from steel (e.g., stainless-steel). In some embodiments, the spring is constructed as a coil spring. In some embodiments, the spring is constructed as a flat spring.

According to at least one aspect, a wearable haptic device is provided. The wearable haptic device includes a garment configured to be worn about at least a portion of a subject, an anchoring element attached to the garment, a tensioning cable coupled to the anchoring element, and a retraction mechanism attached to the garment and coupled to the tensioning cable. The retraction mechanism includes a brake to impede movement of the tensioning cable to impede motion of the anchoring element in at least one direction.

In some embodiments, the wearable haptic device includes at least one guide attached to the garment and configured to guide the tensioning cable.

In some embodiments, the garment is configured to be worn about at least one joint of the subject. In some embodiments, the at least one joint of the subject includes at least one of: a shoulder joint, an elbow joint, a wrist joint, a finger joint, a neck joint, a spine joint, a hip joint, a knee joint, an ankle joint, or a toe joint. In some embodiments, the wearable haptic device includes at least one sensor configured to measure flexion across the at least one joint. In some embodiments, the wearable haptic device includes a controller electrically coupled to the at least one sensor and the retraction mechanism by at least one conductive element integrated into the garment. In some embodiments, the controller is configured to control the retraction mechanism based on the measured flexion across the at least one joint from the at least one sensor. In some embodiments, the at least one conductive element integrated into the garment includes conductive thread. In some embodiments, the at least one conductive element integrated into the garment includes conductive thread.

In some embodiments, the retraction mechanism includes a tensioning mechanism coupled to the tensioning cable and configured to apply a pulling force to the tensioning cable. In some embodiments, the tensioning mechanism includes at least one of an elastic member, a spring, or a motor.

According to at least one aspect, a wearable haptic glove is provided. The wearable haptic glove includes a garment configured to be worn about at least a portion of a hand of a subject, a finger cap attached to the garment and configured to receive at least a portion of a finger of the subject, a sensor configured to measure flexion across at least one finger joint in the hand of the subject, a tensioning cable coupled to the finger cap, and a retraction mechanism attached to the garment and coupled to the tensioning cable. The retraction mechanism includes a brake configured to controllably impede movement of the tensioning cable to impede motion of the anchoring element in at least one direction, an actuator coupled to the brake and configured to receive a control signal and operate the brake based on the received control signal, and a tensioning mechanism coupled to the tensioning cable and configured to apply a pulling force to the tensioning cable.

In some embodiments, the wearable haptic glove includes a controller electrically coupled to the sensor and the retraction mechanism by at least one conductive element integrated into the garment. In some embodiments the controller is configured to receive information from the sensor indicative of the measured flexon across the at least one finger joint, communicate the received information from the sensor to at least one external device, and generate the control signal for the actuator. In some embodiments, the controller is configured to generate the control signal for the actuator based on the received information from the sensor.

Still other aspects, examples, and advantages of these exemplary aspects and examples, are discussed in detail below. Moreover, it is to be understood that both the foregoing information and the following detailed description are merely illustrative examples of various aspects and examples, and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of a particular example. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1 shows an example wearable haptic device, according to some embodiments;

FIG. 2A shows an example glove mechanism without the glove, according to some embodiments;

FIGS. 2B-2C show an example glove mechanism on a glove to form a wearable haptic glove, according to some embodiments;

FIG. 3A shows a side view of a glove mechanism on a glove that is not touching a virtual object, according to some embodiments;

FIG. 3B shows a side view of a glove mechanism on a glove that is touching a virtual object, according to some embodiments;

FIG. 4A shows an example retraction mechanism in an open position, according to some embodiments;

FIG. 4B shows an example retraction mechanism in a resistive position, according to some embodiments;

FIG. 5 shows a distributed system for receiving and controlling hand movements in a virtual environment, according to some embodiments;

FIG. 6 shows a flowchart of an example process for operating a haptic mechanism, according to some embodiments;

FIG. 7 shows a flowchart of an example process for interacting with a haptic mechanism to provide haptic feedback to a user simulating a virtual environment, according to some embodiments; and

FIG. 8 shows a block diagram of an example special-purpose computer system, according to some embodiments.

### DETAILED DESCRIPTION

The inventor has appreciated that conventional virtual reality (VR) and augmented reality (AR) systems do not provide an immersive experience for the human sense of touch and provide little or no feedback to the hands of a user. For example, conventional VR and AR systems may only use vibration feedback integrated into a game controller or other input device to provide feedback to the hands of the user. Using vibration feedback alone, however, provides a poor simulation of interacting with solid objects in a virtual environment. The sensation of holding a solid object is not provided by vibrator feedback alone because the finger motions of the user are not constrained. Thereby, the fingers of the user may move through solid objects in the virtual environment without any resistance.

Existing approaches to constrain motion of a user to simulate grabbing objects in a virtual environment are cumbersome and prohibitively expensive to be manufactured for consumers. The CYBERGRASP by CYBERGLOVE SYSTEMS, for example, typically costs tens of thousands of dollars to purchase and includes a complex exoskeleton that needs to be fitted to a glove by the user. Such a haptic device is unsuited for the consumer electronics market given a price point that is orders of magnitude larger than the typical cost of entire consumer AR and VR systems and the complexity of assembling the device.

Accordingly, the inventor has conceived and developed a haptic mechanism that effectively recreates the sensation of interacting with objects suitable for the consumer electronics market. In some embodiments, the haptic mechanism includes a retractable tensioning cable that couples an anchoring element worn about a portion of a subject to a retraction mechanism. The retraction mechanism may simulate movement of the subject through open space by allowing the retractable tensioning cable (and the anchoring element) to move freely and simulate a collision with an object by limiting movement of the retractable tensioning cable to constrain the motion of the anchoring element. The retraction mechanism may advantageously limit the movement of the tensioning cable through a brake that uses friction to limit the movement of the tensioning cable. Employing a braking mechanism that uses friction to impede movement may allow a small actuator to be employed to control the braking mechanism in place of a larger and more expensive motor to directly apply a force to the tensioning cable. Thereby, the size, cost, and complexity of the haptic mechanism may be reduced.

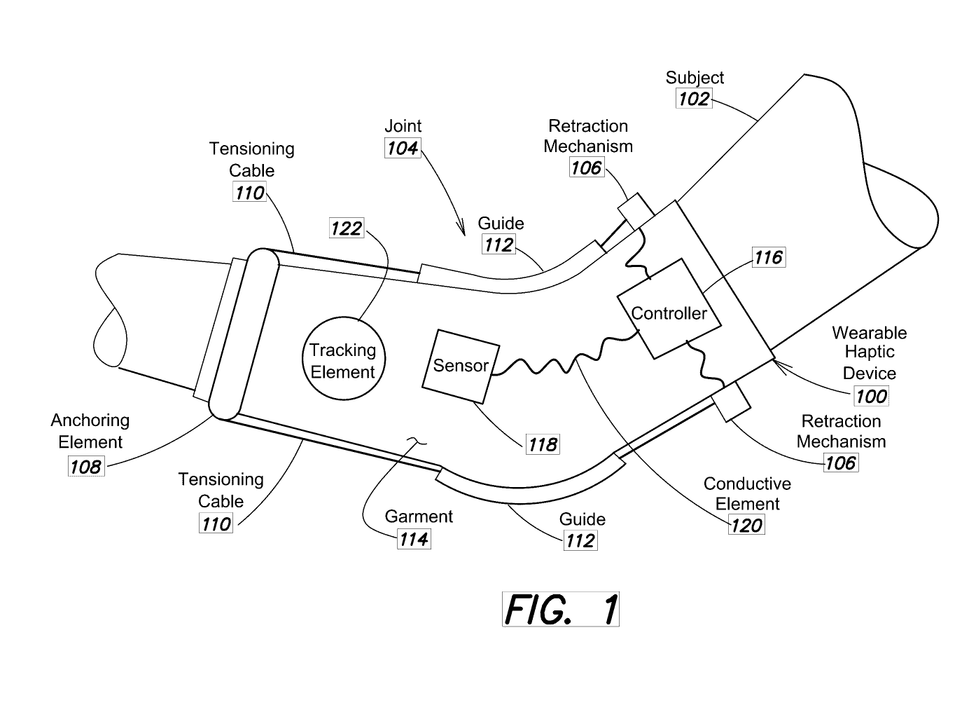

In some embodiments, the haptic mechanism described herein may be attached to a garment configured to be worn about a portion of the subject to form a wearable haptic device. An example of such a haptic device is shown in FIG. 1 by wearable haptic device 100 on a joint 104 of a subject 102. The wearable haptic device 100 may be configured to constrain movement of the joint 104 to simulate interaction with an object. The joint 104 may be any of a variety of joints in the human body such as, but not limited to, a shoulder joint, an elbow joint, a wrist joint, a finger joint, a neck joint, a spine joint, a hip joint, a knee joint, an ankle joint, or a toe joint. As shown, the wearable haptic device 100 includes a garment 114 worn about the joint 104 and an anchoring element 108 that is attached to the garment. The motion of the joint 104 may be constrained by limiting the movement of the anchoring element 108. The movement of the anchoring element 108 may be limited by a tensioning cable 110 that is routed through a guide 112 attached to the garment and controlled by a retraction mechanism 106. The retraction mechanism 106 may simulate movement within open space by allowing the tensioning cable 110 to be extended and retracted freely from the retraction mechanism 106 to permit free movement of the anchoring element 108. The retraction mechanism 106 may simulate a collision with a physical object by disallowing the extension of the tensioning cable 110 from the retraction mechanism 106 and/or pulling the tensioning cable 110 back into the retraction mechanism 106. Thereby, movement of anchoring element 108 is constrained. The retraction mechanism 106 may be controlled by a controller 116 that is attached to the garment 114 and electrically coupled to the retraction mechanism 106 by the conductive element 120 integrated into the garment 114. The controller 116 may receive information from a sensor 118 indicative of, for example, a flexion of the joint 104 through the conductive element 120. The controller 116 may employ the information received from the sensor 118 to control the retraction mechanism 106. It should be appreciated that the wearable haptic device 100 may further include a tracking element 122 to facilitate tracking of the wearable haptic device 100 in three-dimensional (3D) space by a VR or AR system. For example, the tracking element 122 may be an object with a distinctive shape that is identifiably in images captured by a camera. In another example, the tracking element 122 may be a light source (e.g., an infrared light emitting diode (LED)) that emits light that may be detected and tracked by a sensor.

The retraction mechanism 106 may be constructed to control the movement of the tensioning cable 110 and, thereby, control movement of the anchoring element 108. The retraction mechanism 106 may be configured to keep the tensioning cable 110 taught while still allowing the tensioning cable 110 to extend from the retraction mechanism 106. For example, the retraction mechanism 106 may include a spring coupled to the tensioning cable 110 that may expand to allow the tensioning cable 110 to extend from the retraction mechanism 106 and contract to keep the tensioning cable 110 taught. The retraction mechanism 106 may simulate a collision with an object by disallowing the tensioning cable 110 to further extend from the retraction mechanism 106. For example, the retraction mechanism 106 may include a brake that uses friction to impede the movement of the tensioning cable 110 that is controlled by an actuator. In this example, the retraction mechanism 106 may control the actuator to apply the brake to the impede movement of the tensioning cable 110. The brake may be constructed in any of a variety of ways. For example, the brake may include a U-brake, a channel brake, and/or a disk brake. Employing a braking to impede movement of the tensioning cable 110 may advantageously allow a smaller actuator to be employed relative to other approaches because the actuator does not directly apply a force to the tensioning cable 110 that impedes movement. Thereby, an actuator may be selected that provides less torque than is otherwise required to impede movement of the tensioning cable 110. It should be appreciated that the retraction mechanism 106 may use other techniques to impede movement of the tensioning cable 110 apart from a brake. For example, the retraction mechanism 106 may employ a motor to directly apply force to the tensioning cable 110 to constrain the movement of the tensioning cable 110.

The guide 112 may route the tensioning cable 110 through the wearable haptic device 100. For example, the guide 112 may route the tensioning cable 110 over an inner or outer portion of the joint 104. The guide 112 may be attached to the garment 114 to advantageously minimize the bulkiness of the wearable haptic device 100.

The anchoring element 108 may be configured to constrain the movement of the joint 104 when the retraction mechanism 106 impedes the movement of the tensioning cable 110. The anchoring element 106 may be attached to the garment 114 and constructed from a different material than the garment 114. For example, the garment 114 may be constructed of fabric and the anchoring element may be constructed from rubber, plastic, metal, or any combination thereof. The anchoring element 106 may be located distal from the joint 104 that is being controlled. For example, the joint 104 may be an elbow joint and the anchoring element 108 may be constructed as a band to be worn about a forearm of the subject 102. In another example, the joint 104 may be a finger joint and the anchoring element 108 may be constructed as a finger cap to be worn about an end of a finger of the subject 102.

In some embodiments, the wearable haptic device 100 may constrain the movement of the anchoring element 108 in multiple directions. In these embodiments, the wearable haptic device 100 may employ multiple retraction mechanisms 106 that are individually controlled and each coupled to the anchoring element 108 with a separate tensioning cable 110 as shown in FIG. 1. For example, the retraction mechanism 106 at the bottom of the joint 104 may constrain the tensioning cable 110 at the bottom of the joint 104 to impede the joint 104 from being closed. Conversely, the retraction mechanism 106 on the top of the joint 104 may constrain the tensioning cable 110 at the top of the joint 104 to impede the joint 104 from being opened. Thereby, the wearable haptic device 100 may constrain the joint 104 from opening and/or closing. It should be appreciated that more (or fewer) retraction mechanisms 106, tensioning cables 110, guides 112, and/or anchoring elements 108 may be employed based on the particular movements being controlled.

The sensor 118 may be integrated into the garment 114 and configured generate information for the wearable haptic device 100 and/or for another device communicatively coupled to the wearable haptic device 100, such as one or more components of an AR or VR system. In some embodiments, the sensor 118 may be configured to measure movement of the wearable haptic device 100. For example, the sensor 118 may include an accelerometer, a magnetometer, a gyroscope, and/or an inertial measurement unit (IMU). In other embodiments, the sensor 118 may be configured to measure flexion of the joint 104. In these embodiments, the sensor 118 may include, for example, rotary encoders, rotary potentiometers, flex sensors, and/or hall effect sensors. It should be appreciated that any number of sensors 118 and combination of sensor types may be employed in the wearable haptic device 100. For example, the wearable haptic device 100 may include a first sensor 118 that is an IMU and a second sensor 118 that is configured to measure flexion of the joint 104.

The controller 116 may control one or more components in the wearable haptic device 100 and/or read information from one or more sensors in the wearable haptic device 100. The controller 116 may be implemented as, for example, a microcontroller. The controller 116 may be communicatively coupled to one or more external components by a wired and/or wireless connection. For example, the controller 116 may be communicatively coupled to a computer system generating a virtual world by a USB connection and/or a BLUETOOTH connection.

In some embodiments, the controller 106 may be configured to read the sensor 118 to obtain sensor information. The controller 116 may provide the information obtained from the sensor 118 to one or more external devices communicatively coupled to the controller 116. For example, the sensor 118 may include an IMU and the controller 106 may obtain sensor information from the IMU indicative of movement of the wearable haptic device 100 and send the sensor information to a computer system generating a virtual world. Alternatively (or additionally), the controller 116 may use the information received from the sensor 118 to control the retraction mechanism 106. For example, the sensor 118 may be configured to measure a flexion of the joint 104 and the controller may be configured to determine whether the flexion of the joint 104 exceeds a threshold and direct the retraction mechanism 106 to impede the movement of the anchoring element 108 responsive to the threshold being transgressed.

The conductive elements 120 may electrically couple one or more components of the wearable haptic device 100, such as the sensor 118, the controller 116, and/or the retraction mechanism 106. The conductive elements 120 may be advantageously integrated into the garment 114 to reduce the possibility of wires snagging on real-world objects during use by the user. The conductive elements 120 may be, for example, conductive thread integrated into the garment and/or one or more wires integrated into the garment.

The garment 114 may be configured to be worn about at least part of a subject 102. The garment 114 may be constructed from, for example, fabric. In some embodiments, the garment 114 may include flexible and/or breathable fabric. It should be appreciated that the garment 114 may be constructed in any of a variety of ways and may not entirely cover the joint 104 as shown in FIG. 1.

In some embodiments, the various components of the wearable haptic device 100 (e.g., the controller 116, the sensor 118, and/or the retraction mechanism 106) may receive power from a power source integrated into the wearable haptic device 100 and/or receive power from an external power source. For example, the controller 116 may be communicatively coupled to a computer system by a wired connection (e.g., by a USB connection) and receive power from the computer system over the wired connection. In this example, the controller 116 may provide power to the other components of the wearable haptic device 100. In another example, the wearable haptic device 100 may include a power source (not shown) such as a battery receptacle to receive batteries and/or a rechargeable battery pack. In this example, the power source may be integrated into the garment 114 and/or removable from the wearable haptic device 100.

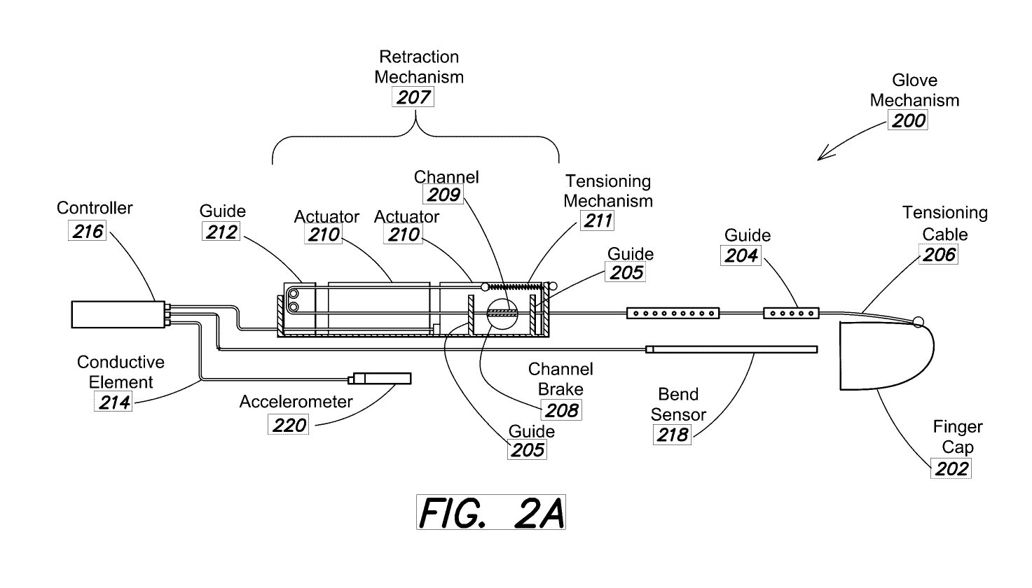

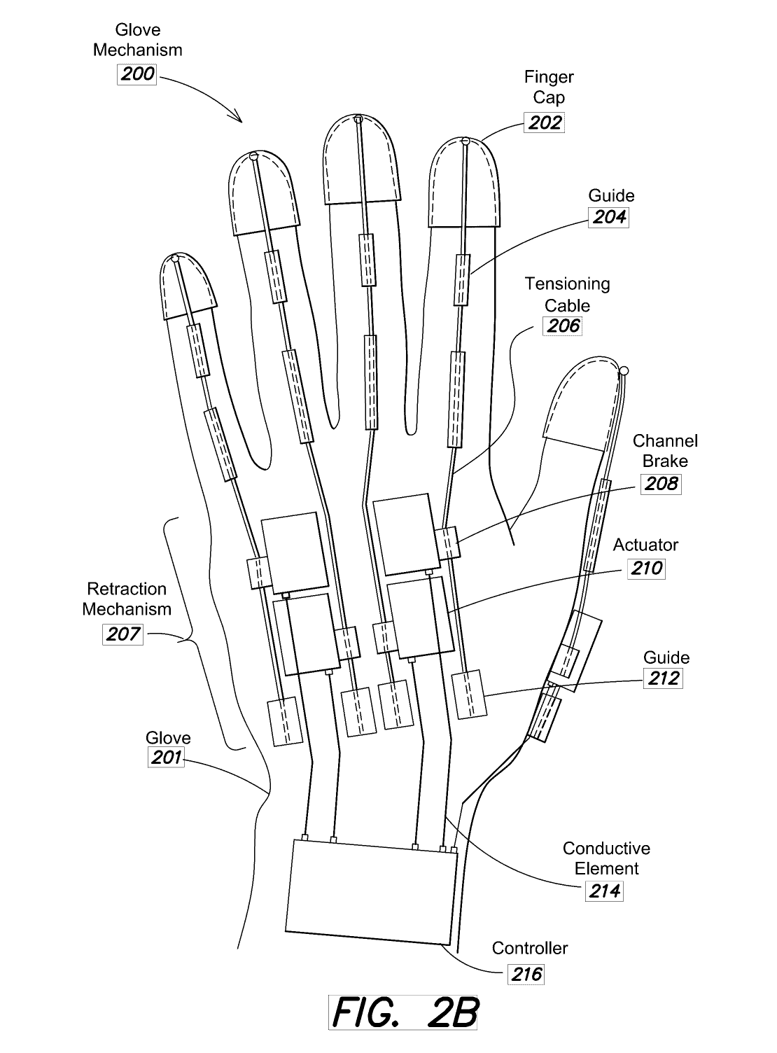

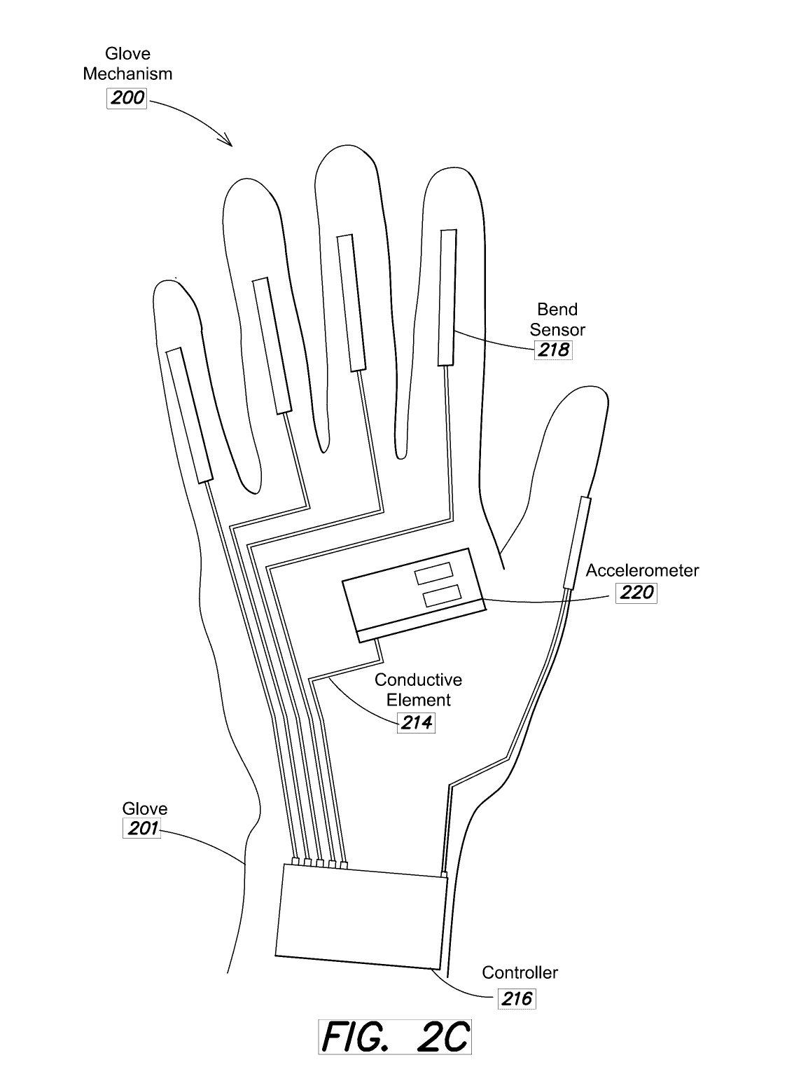

According to some aspects of the present disclosure, the haptic mechanism may be implemented as a glove mechanism to provide haptic feedback to a user's hands within a virtual reality environment. An example of such a glove mechanism is shown in FIG. 2A by glove mechanism 200. FIGS. 2B and 2C each show views of a portion of the glove mechanism 200 attached to a glove 201 to form a haptic glove. As shown, the glove mechanism 200 includes finger caps 202, guides 204, tensioning cables 206, conductive elements 214, a controller 216, and retraction mechanisms 207. The retraction mechanisms 207 include a channel brake 208 with a channel 209, actuators 210, guides 205 and 212, and tensioning mechanism 211.

The finger caps 202 may each house a portion of a finger inserted into the glove 201. The finger caps 202 may function similarly (or identically) to the anchoring element 108 described above with respect to FIG. 1. For example, the finger caps 202 may function as a structural element that provide resistive and/or retractive force to a portion of the user (e.g., the fingertips). The finger caps 202 may be provided for each of the fingers and may be attached to the glove 201. The finger caps 202 may be constructed from a different material than the glove 201. For example, the glove 201 may be constructed from one or more fabrics and the finger caps 202 may be constructed from metal, plastic, rubber, or any combination thereof.

The tensioning cable 206 may couple the retraction mechanism 207 to the finger cap 202. The tensioning cable 206 may be similar (or identical) to the tensioning cable 110 described above with respect to FIG. 1. The tensioning cable 206 may provide a resistive force to the finger caps 202 when the retraction mechanism 207 impedes the movement of the tensioning cable 206. For example, the retraction mechanism 207 may use the channel brake 208 to impede the extension of the tensioning cable 206 and, thereby, stop a finger of the user from being bent beyond a particular point. The tensioning cable 206 may be routed through guides 204 that are integrated into the tops of the fingers of the glove 201. These guides 204 may be similar (or identical) to the guides 112 shown in FIG. 1. The tensioning cable 206 may be routed through guides 205 proximate the channel brake 208 and the guide 212 behind the actuators 210.

The retraction mechanism 207 may be constructed to apply a resistive force and/or retractive force to the finger caps 202 via the tensioning cables 206. The retraction mechanism 207 may be one example implementation of the retraction mechanism 106 shown in FIG. 1. In some embodiments, the retraction mechanism 207 employs the channel brake 208 to impede the movement of the tensioning cable 206. The channel brake 208 includes the channel 209 through which the tensioning cable 206 is routed. The channel brake 208 may be operated by changing the orientation of the channel 209. For example, the channel 209 may be parallel to a top surface of the glove 201 to allow the tensioning cable 206 to move freely through the channel 209. In this example, the channel 209 may be rotated 90 degrees to make the channel perpendicular to a top surface of the glove 201 and impede the movement of the tensioning cable 206 through the channel 209. The channel 209 may be rotated beyond 90 degrees to pull back the tensioning cable 206 and apply a retractive force to the finger cap 206. In some embodiments, the channel brake 208 may be operated by the actuator 210 based on signals received from the controller 216 via the conductive elements 214. For example, the actuator 210 control a rotation of the channel 209 in the channel brake 208 to allow the tensioning cable 206 to move freely through the channel 209 or impede the movement of the tensioning cable 206 in the channel 209. The actuator 210 may be implemented using any of a variety of electrical, mechanical and/or pneumatic devices such as a stepper motor, a servomotor, and/or a solenoid. The control signals for the actuators 210 may be received via conductive elements 214.

The retraction mechanism 207 may include tensioning mechanism 211 that is constructed to keep the tensioning cable 206 taught and take up any slack in the tensioning cable 206. The tensioning mechanism 211 may include one or more passive or active components that can be used to apply pressure, such as, for example, elastic members, springs, and/or motors.

In some embodiments, the glove mechanism 200 may include one or more sensors integrated into the glove 201 to generate information indicative of a position of the glove mechanism 200. For example, glove mechanism 200 may include bend sensors 218 to measure a relative flexion of a finger of the user. The bend sensors 218 may be located along one or more fingers of the glove 201. The glove mechanism 200 may also include an accelerometer 220 to measure movement of the hand of the user. The output of these sensors may be provided to the controller 216 via the conductive elements 214.

The controller 216 may be integrated into the glove 201 and receive control signals from external devices and provide sensor and status information to these external devices. The controller 216 may be implemented as, for example, a microcontroller. The controller 216 may be capable of communicating using one or more protocols, within one or more message types. In some embodiments, responsive to actions performed in a virtual environment, one or more control signals may be provided to the retraction mechanism 207 to assert a resistive and/or retractive force to one or more of the finger caps 202 to simulate interaction with the virtual environment. In some embodiments, the controller 216 may read various sensors (e.g., the bend sensor 218 and/or the accelerometer 220) and provide the output from these sensors to an external device.

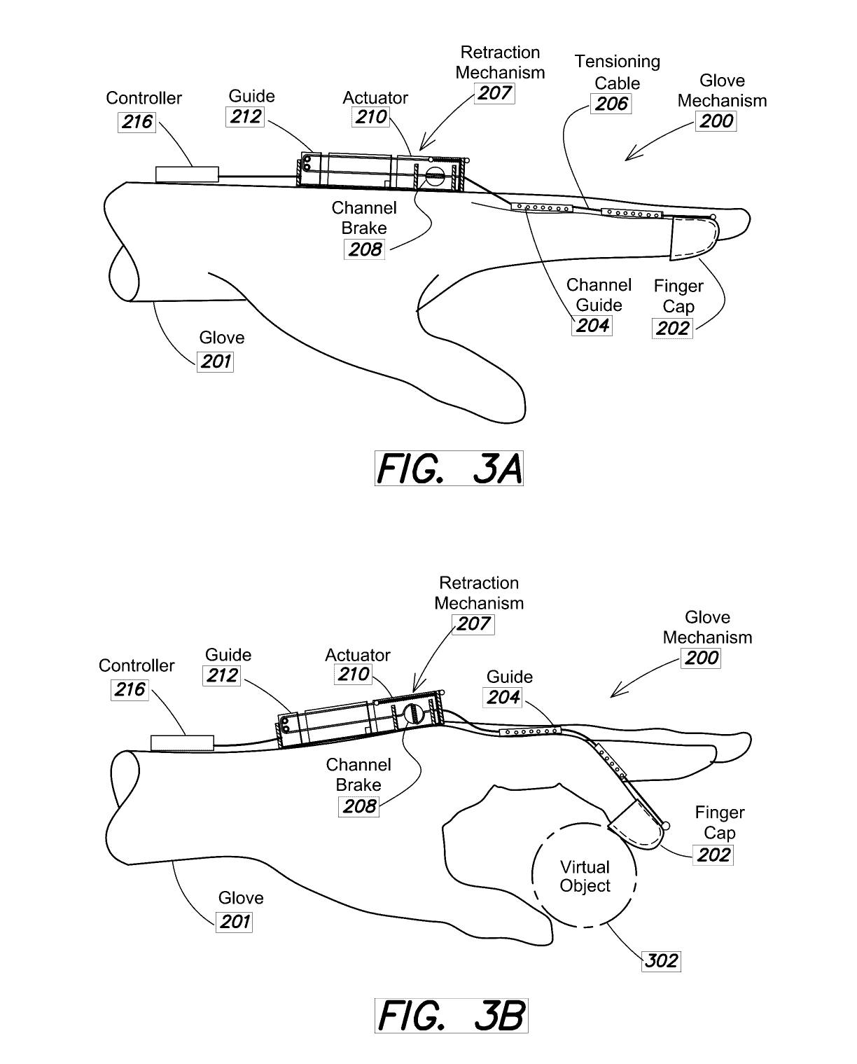

FIGS. 3A and 3B show the glove mechanism 200 on a glove 201 when the user is interacting with a virtual object 302. In particular, FIG. 3A shows the glove mechanism 200 when the channel brake 208 is in the open position and allowing the tensioning cable 210 to move freely and FIG. 3B shows the glove mechanism 200 when the channel brake 208 is in the closed position and impeding movement of the tensioning cable 210 to stop a finger of the user from passing through a virtual object 302. As shown in FIG. 3A, the channel brake 208 may be rotated by the actuator 210 such that the channel in the channel brake 208 is parallel (or substantially parallel) with a top surface of the glove 201 to allow the tensioning cable 206 to move freely through the channel. As shown in FIG. 3B, the actuator 210 may rotate the channel brake 90 degrees (or approximately 90 degrees) to impede the movement of the tensioning cable 206 through the channel to stop the finger cap 202 (and the finger of the user inside the finger cap) from passing through the virtual object 302.

It should be appreciated that the retraction mechanism 207 may be configured to provide partial resistance to the finger cap 202. For example, the virtual object 302 may be a semi-solid object in the virtual world (as opposed to a solid object). In this example, the retraction mechanism 207 may apply a smaller resistive force to the finger cap 202 by rotating the channel brake 208 less than 90 degrees (e.g., 45 degrees) to simulate touching a semi-solid object. Further, the retraction mechanism 207 may be configured to provide a retractive force to the finger cap 202 by rotating the channel brake 208 beyond 90 degrees to pull back the tensioning cable 206.

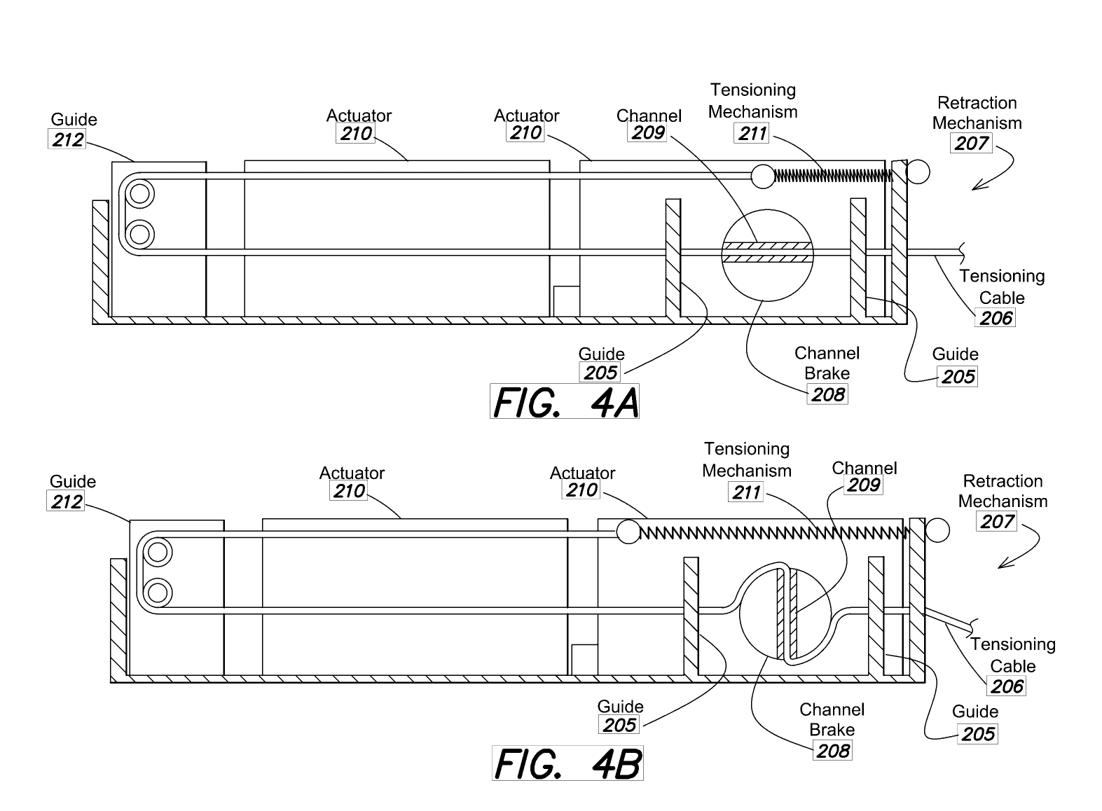

FIGS. 4A and 4B show a magnified view of the retraction mechanism 207. In particular, FIG. 4A shows a magnified view of the retraction mechanism 207 when the channel brake 208 is in the open position and FIG. 4B shows a magnified view of the retraction mechanism 207 when the channel brake 208 is in the closed position. As previously described, the channel brake 208 allows the tensioning cable 206 to move freely through the channel 209 when the channel brake 208 is open and impedes movement of the tensioning cable 206 when the channel brake 208 is closed. The guides 205 on either side of the channel brake 208 may increase a frictional force applied to the tensioning cable 210 when the channel brake 208 is in the closed position.

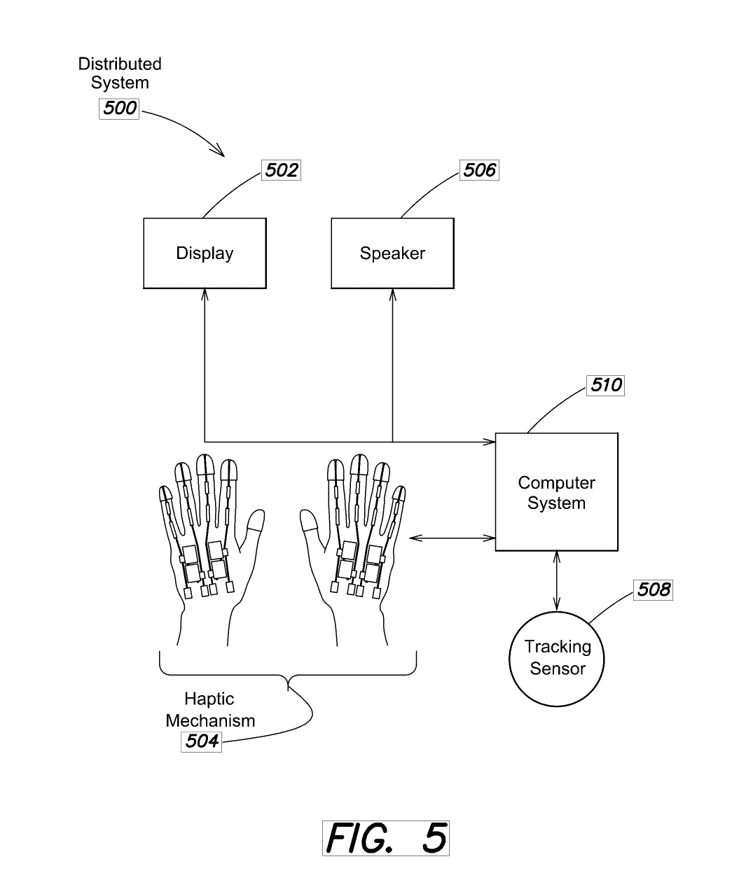

In some embodiments, the haptic mechanisms and devices disclosed herein may be employed in conjunction with VR or AR systems to simulate interaction with virtual objected in a virtual (or augmented) world. An example of a distributed system including the haptic device employed in a VR or AR system is shown in FIG. 5 by distributed system 500. The distributed system 500 may be constructed for receiving and controlling hand movements in a virtual environment. As shown, the system 500 includes a computer system 510 in communication with a display 502, a speaker 506, a haptic mechanism 504, and a tracking sensor 508. The haptic mechanism 504 may be any of the haptic mechanisms or devices described herein and worn by a user for the purpose of performing activities within a virtual environment. Such a virtual environment may be simulated by the computer system 510 which maintains a virtual reality representation including a representation of virtual objects within the environment, along with a status of one or more devices of the user (e.g., a present status of the haptic mechanism 504).

The computer system 510 may create a virtual world and provide an immersive experience for the user in the virtual world via the input and output devices communicatively coupled to the computer system 510. For example, the display 502 may be a headset and the computer system 510 may stream images to the headset that tracks the head motions of the user to provide an immersive experience to the user's sense of sight. The computer system 510 may provide an immersive experience to the user's sense of sound by playing sound through the speaker 506 that changes as the user's head move. The computer system 510 may control the haptic mechanism 504 to provide an immersive experience to the user's sense of touch by directing the haptic mechanism 504 to provide feedback to a portion of the subject to simulate interaction with virtual objects. The computer system 504 may track the movement of the haptic mechanism 504 in 3D space by various sensors integrated into the haptic mechanism 504 (such as an IMU) and/or separate from the haptic mechanism 504 (such as the tracking sensor 508). For example, the haptic mechanism 504 may include one or more infrared LEDs and the computer system 510 (via the tracking sensor 508) may track the location of the infrared LEDs in 3D space to determine the location of the haptic mechanism.

In some embodiments, the system 500 may maintain status information relating to the haptic mechanism 504. For example, the haptic mechanism 504 may be a glove mechanism and the status information may include a hand orientation and/or finger flexure. Similarly, system 500 may be configured to provide one or more commands which are communicated and executed by the haptic mechanism 504. For example, responsive to an action within the virtual environment, a command may be communicated via a communication interface of the computer system 510 to the haptic mechanism 504. For instance, one command may correspond to performing a braking action on one or more fingers. A controller associated with the haptic mechanism 504 may receive such a command and signal one or more elements of the haptic mechanism 504 accordingly.

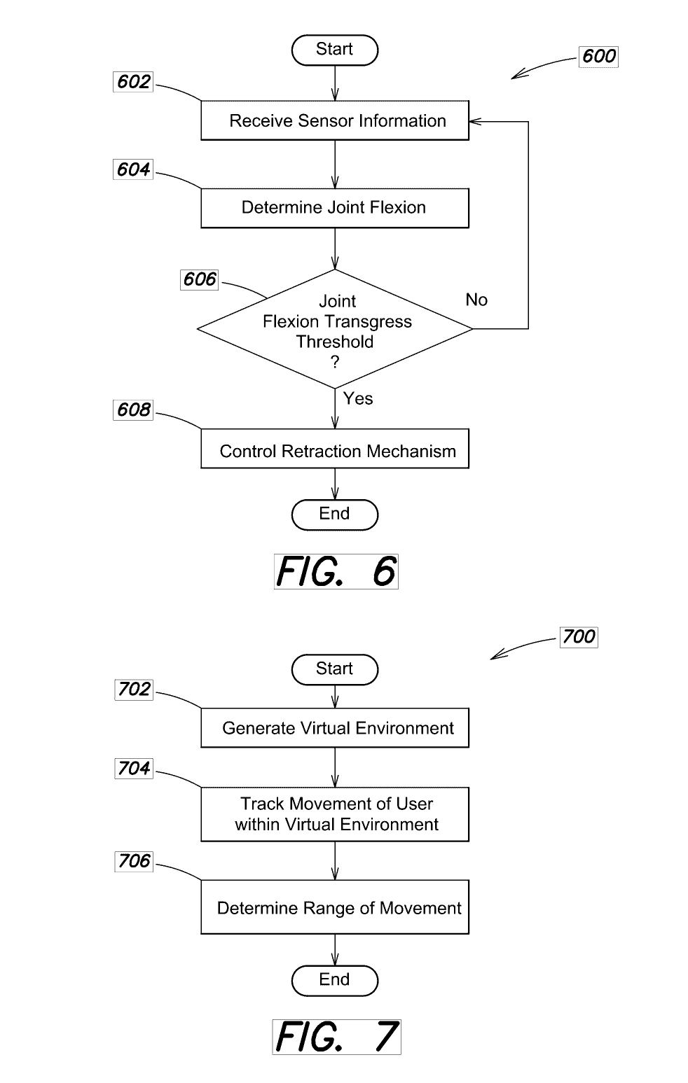

As discussed above, some embodiments of the haptic mechanism include a controller that may perform one or more functions to operate the haptic mechanism. For example, the controller may read one or more sensors and control a retraction mechanism based on the information read from the sensors. An example of such a process performed by a controller of a haptic mechanism is illustrated by process 600 in FIG. 6.

In act 602, the controller receives sensor information. The controller may receive sensor information by reading one or more sensors in the haptic mechanism. For example, the haptic mechanism may include a sensor configured to measure a flexion of a joint and the controller may read the sensor to obtain sensor information indicative of the flexion of the joint.

In act 604, the controller may determine the flexion of a joint. For example, this controller may interpret the sensor information received in act 602 to determine the flexion of the joint. It should be appreciated that the controller may determine the flexion of the joint in combination with one or more external devices. For example, the controller may transmit (via a wireless or wired connection) the sensor information received in act 602 an external device, such as a computer system in a VR or AR system. In this example, the external device may interpret the received sensor information to determine the flexion of the joint and return the determined result to the controller.

In act 606, the controller may determine whether the joint flexion transgresses a threshold. The threshold may be received from, for example, an external system. The threshold may be representative of one or more virtual objects in a virtual environment. For example, the threshold may indicate that an elbow joint of the user should not extend beyond 50 degrees. In this example, the threshold may be indicative of a solid object in a virtual world being under a forearm of the user. If the controller determines that the joint position has not been transgressed, the controller may return to act 602 and continue receiving sensor information. Otherwise, the controller may proceed to act 608 and control the retraction mechanism to stop additional flexion in the joint and/or change the flexion of the joint. For example, in act 608, the controller may generate a control signal for an actuator that controls a brake in the haptic mechanism. In this example, the actuator may close the brake to impede movement of a tensioning cable coupled to an anchoring element to impede additional flexion.

As discussed above, the haptic mechanism may be part of a VR or AR system and provides haptic feedback to simulate virtual objects in the virtual (or augmented world). In these systems, a computer system (e.g., computer system 510) may perform one or more processes to direct the haptic mechanism to provide feedback to simulate interaction with virtual objects in the virtual (or augmented) world generated by the computer system. An example of such a process performed by the computer system is illustrated by process 700 in FIG. 7.

In act 702, the computer system may generate a virtual environment. The computer system may generate the virtual environment based on information stored in a computer readable medium. For example, a VR game may be installed on the computer system. In this example, the computer system may execute the game and create the virtual environment from the game. This virtual environment may include various objects that may be interacted with by the user.

In act 704 the computer system may track the movement of the user within the virtual environment. The computer system may track the movement of the user in the virtual world by reading one or more sensors. These sensors may be integrated into the haptic mechanism and/or external from the haptic mechanism. For example, the haptic mechanism may include one or more tracking elements such as infrared LEDs. In this example the computer system may be communicatively coupled to a tracking sensor (e.g., tracking sensor 508) such as an infrared detector. The movement of the infrared LEDs in 3D space may be tracked based on information gathered from the tracking sensor. In another example, the haptic mechanism may include an IMU that measures movement of the haptic mechanism. In this example, this computer system may receive information from the IMU (either directly or indirectly) and track the movement of the haptic mechanism in 3D space using the information from the IMU.

In act 706, the system determines the range of movement for the user in the virtual environment. The range of movement may be determined based on the location of the user in the virtual environment and the virtual objects in the virtual environment at the location of the user. For example, the system may determine how far the user can extend a joint without colliding with a virtual object in the virtual world. The determined range of movement may be employed to, for example, provide thresholds to the haptic mechanism indicative of how far a particular joint may be extended without providing haptic feedback.

The processes described above are illustrative embodiments and are not intended to limit the scope of the present disclosure. The acts in the processes described above may be ordered in any suitable way. Accordingly, embodiments may be constructed in which acts are performed in an order different than illustrated, which may include performing some acts simultaneously, even though shown as sequential acts in illustrative embodiments.

In some embodiments, a special-purpose computer system (e.g., computer system 510 shown in FIG. 5) can be specially configured as disclosed herein to identify printed objects. The operations described herein can also be encoded as software executing on hardware that may define a processing component, define portions of a special purpose computer, reside on an individual special-purpose computer, and/or reside on multiple special-purpose computers.

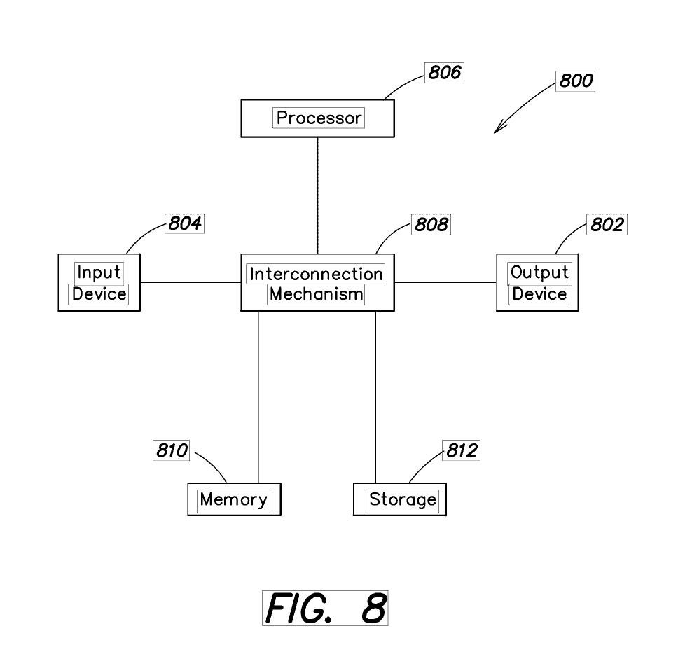

FIG. 8 shows a block diagram of an example special-purpose computer system 800 which may perform various processes described herein including the process illustrated above in FIG. 7. As shown in FIG. 8, the computer system 800 includes a processor 806 connected to a memory device 810 and a storage device 812. The processor 806 may manipulate data within the memory 810 and copy the data to storage 812 after processing is completed. The memory 810 may be used for storing programs and data during operation of the computer system 800. Storage 812 may include a computer readable and writeable nonvolatile recording medium in which computer executable instructions are stored that define a program to be executed by the processor 806. According to one embodiment, storage 812 comprises a non-transient storage medium (e.g., a non-transitory computer readable medium) on which computer executable instructions are retained.

Components of computer system 800 can be coupled by an interconnection mechanism 808, which may include one or more busses (e.g., between components that are integrated within a same machine) and/or a network (e.g., between components that reside on separate discrete machines). The interconnection mechanism enables communications (e.g., data, instructions) to be exchanged between system components of system 800. The computer system 800 may also include one or more input/output (I/O) devices 802 and 804, for example, a keyboard, mouse, trackball, microphone, touch screen, a printing device, display screen, speaker, etc. to facilitate communication with other systems and/or a user.

The computer system 800 may include specially-programmed, special-purpose hardware, for example, an application-specific integrated circuit (ASIC). Aspects of the present disclosure can be implemented in software, hardware or firmware, or any combination thereof. Although computer system 800 is shown by way of example, as one type of computer system upon which various aspects of the present disclosure can be practiced, it should be appreciated that aspects of the present disclosure are not limited to being implemented on the computer system as shown in FIG. 8. Various aspects of the present disclosure can be practiced on one or more computers having a different architectures or components than that shown in FIG. 8.

Various embodiments described above can be implemented using an object-oriented programming language, such as Java, C++, Ada, or C# (C-Sharp). Other programming languages may also be used. Alternatively, functional, scripting, and/or logical programming languages can be used. Various aspects of the present disclosure can be implemented in a non-programmed environment (e.g., documents created in HTML, XML or other format that, when viewed in a window of a browser program, render aspects of a graphical-user interface (GUI) or perform other functions). The system libraries of the programming languages are incorporated herein by reference. Various aspects of the present disclosure can be implemented as programmed or non-programmed elements, or any combination thereof.

It should be appreciated that various embodiments can be implemented by more than one computer system. For instance, the system can be a distributed system (e.g., client server, multi-tier system) that includes multiple special-purpose computer systems. These systems can be distributed among a communication system such as the Internet.

Various aspects of the present disclosure may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Further, some actions are described as taken by a “user.” It should be appreciated that a “user” need not be a single individual, and that in some embodiments, actions attributable to a “user” may be performed by a team of individuals.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The terms “approximately,” “substantially,” and “about” may be used to mean within ±20% of a target value in some embodiments, within ±10% of a target value in some embodiments, within ±5% of a target value in some embodiments, and yet within ±2% of a target value in some embodiments. The terms “approximately,” “substantially,” and “about” may include the target value.

Having thus described several aspects of at least one example, it is to be appreciated that various alterations, modifications, and improvements will readily occur to those skilled in the art. For instance, examples and embodiments disclosed herein may also be used in other contexts. Such alterations, modifications, and improvements are intended to be part of this disclosure, and are intended to be within the scope of the examples discussed herein. Accordingly, the foregoing description and drawings are by way of example only.

What is claimed is:

1. A haptic mechanism comprising:
an anchoring element configured to be worn about a portion of a subject;
a tensioning cable coupled to the anchoring element; and
a retraction mechanism coupled to the tensioning cable, the retraction mechanism including a brake configured to controllably impede movement of the tensioning cable to impede motion of the anchoring element in at least one direction.

2. The mechanism of claim 1, wherein the anchoring element includes a finger cap configured to receive a portion of a finger of the subject.

3. The mechanism of claim 1, wherein the brake includes a channel brake having a channel, and wherein the tensioning cable is routed through the channel of the channel brake.

4. The mechanism of claim 3, wherein the retraction mechanism further includes an actuator configured to rotate the channel brake to impede movement of the tensioning cable through the channel.

5. The mechanism of claim 1, wherein the brake includes at least one of a U-brake, a channel brake, or a disc brake.

6. The mechanism of claim 1, wherein the tensioning cable is retractable and contained within the haptic mechanism.

7. The mechanism of claim 1, wherein the retraction mechanism includes at least one of a stepper motor, a servomotor, a solenoid, or an actuator configured to operate the brake to apply a braking force to the tensioning cable.

8. The mechanism of claim 1, further comprising at least one sensor adapted to measure flexion across at least one joint of the subject.

9. The mechanism of claim 1, wherein the retraction mechanism includes a tensioning mechanism coupled to the tensioning cable and configured to apply a pulling force to the tensioning cable.

10. The mechanism of claim 9, wherein the tensioning mechanism includes at least one of an elastic member, a spring, or a motor.

11. A wearable haptic device comprising:
a garment configured to be worn about at least a portion of a subject;
an anchoring element attached to the garment;
a tensioning cable coupled to the anchoring element; and
a retraction mechanism attached to the garment and coupled to the tensioning cable, the retraction mechanism including a brake to impede movement of the tensioning cable to impede motion of the anchoring element in at least one direction.

12. The device of claim 11, further comprising at least one guide attached to the garment and configured to guide the tensioning cable.

13. The device of claim 11, wherein the garment is configured to be worn about at least one joint of the subject.

14. The device of claim 13, wherein the at least one joint of the subject includes at least one of: a shoulder joint, an elbow joint, a wrist joint, a finger joint, a neck joint, a spine joint, a hip joint, a knee joint, an ankle joint, or a toe joint.

15. The device of claim 13, further comprising at least one sensor configured to measure flexion across the at least one joint.

16. The device of claim 15, further comprising a controller electrically coupled to the at least one sensor and the retraction mechanism by at least one conductive element integrated into the garment, the controller being configured to control the retraction mechanism based on the measured flexion across the at least one joint from the at least one sensor.

17. The device of claim 16, wherein the at least one conductive element integrated into the garment includes conductive thread.

18. The device of claim 11, wherein the retraction mechanism includes a tensioning mechanism coupled to the tensioning cable and configured to apply a pulling force to the tensioning cable.

19. The device of claim 18, wherein the tensioning mechanism includes at least one of an elastic member, a spring, or a motor.

20. A wearable haptic glove comprising:
a garment configured to be worn about at least a portion of a hand of a subject;
a finger cap attached to the garment and configured to receive at least a portion of a finger of the subject;
a sensor configured to measure flexion across at least one finger joint in the hand of the subject;
a tensioning cable coupled to the finger cap;
a retraction mechanism attached to the garment and coupled to the tensioning cable, the retraction mechanism including:
a brake configured to controllably impede movement of the tensioning cable to impede motion of the anchoring element in at least one direction;
an actuator coupled to the brake and configured to receive a control signal and operate the brake based on the received control signal; and
a tensioning mechanism coupled to the tensioning cable and configured to apply a pulling force to the tensioning cable; and
a controller electrically coupled to the sensor and the retraction mechanism by at least one conductive element integrated into the garment, the controller being configured to receive information from the sensor indicative of the measured flexon across the at least one finger joint, communicate the received information from the sensor to at least one external device, and generate the control signal for the actuator.
